(19) United States
(12) Patent Application Publication
(10) Pub. No.: US 2011/0112926 A1
(43) Pub. Date: May 12, 2011

(54) Method and System for Producing Personalized Computing Devices

(76) Inventors: Duncan Robert Kerr, San Francisco, CA (US); David Robbins Falkenburg, San Jose, CA (US)

(21) Appl. No.: 12/615,803

(22) Filed: Nov. 10, 2009

(51) Int. Cl. G06Q 30/00; G06Q 50/00; G06F 15/16; G06F 3/048; G06F 9/24

(52) U.S. Cl. 705/26.5; 709/219; 715/738; 713/1; 715/810

(57) ABSTRACT

Methods, systems and apparatus for producing a pre-configured computing device are disclosed. In one embodiment, a computing device that has been purchased can be customized for a recipient prior to being delivered to the recipient. The customization can be performed based on configuration data that is associated with the recipient. The customization can, for example, vary depending on available configuration data associated with the recipient and/or user customization selections. Advantageously, the customization can personalize the computing device for the recipient such that substantially less participation (e.g., time) is required by the recipient to setup the computing device.

### BACKGROUND OF THE INVENTION

1. Field of the Invention

The present invention relates to computing devices and, more particularly, to personalization of computing devices.

2. Description of the Related Art

Today, personal computers are used both in the home and at work. Over time, personal computers eventually become broken or outdated. It is common for a user to purchase a more modern personal computer when their existing computer breaks downs or is deemed outdated. Unfortunately, however, when a user obtains a replacement computer, there are numerous actions required by the user to setup the computer so that it operates generally as did the former computer, though typically faster and more efficient. These numerous actions for setup of the computer are burdensome to users in terms of the substantial amount of time it requires as well as the obscure information that may be required from the users.

Therefore, there is a need for improved ways to setup computers for users.

### SUMMARY

Methods, systems and apparatus for producing a pre-configured computing device are disclosed. In one embodiment, a computing device that has been purchased can be customized for a recipient prior to being delivered to the recipient. The customization can be performed based on configuration data that is associated with the recipient. The customization can, for example, vary depending on available configuration data associated with the recipient and/or user customization selections. Advantageously, the customization can personalize the computing device for the recipient such that substantially less participation (e.g., time) is required by the recipient to setup the computing device.

The invention can be implemented in numerous ways, including as a method, system, device, or apparatus (including computer readable medium and graphical user interface). Several embodiments of the invention are discussed below.

As a method for producing a personalized computer, one embodiment can, for example, include at least: receiving a request to purchase a computer, the request including a unique identifier associated with a purchaser; retrieving, from an on-line repository, configuration data associated with the purchaser using at least the unique identifier; personalizing the computer being purchased based at least in part on the retrieved configuration data; and thereafter delivering the personalized computer to the purchaser.

As a computer fulfillment system, one embodiment can, for example, include at least a request interface, a memory, a personalization manager, and a delivery interface. The request interface can be configured to receive a computer purchase request specifying a computer being purchased. The computer purchase request can also include or reference configuration information to be utilized in configuring the computer being purchased. The memory of the computer fulfillment system can be configured to store the configuration information to be utilized in configuring the computer being purchased. The personalization manager can operate to pre-configure the computer being purchased based at least in part on the configuration information. The delivery interface can be configured to initiate delivery of the pre-configured computer to a recipient.

As a method of producing a personalized computer, one embodiment includes at least: receiving a request to purchase a computer for a recipient; determining whether the computer to be purchased is to be personalized; obtaining available attribute data pertaining to the recipient; determining personalization to be provided to the computer based on the available attribute data pertaining to the recipient; and producing a personalized computer for the recipient based on the determined personalization.

As a method of producing a personalized computer, another embodiment includes at least: interacting with a remote online commerce server to purchase a computer; querying a user of the client device whether the computer being purchased is to be personalized for a recipient; retrieving available personalization data associated with the recipient; displaying personalization options for the computer being purchased based on the available personalization data; receiving a selection of one or more of the personalization options from the user; forming a personalization data set based on the one or more of the personalization options selected and based on the available personalization data; and sending a computer purchase request to a computer acquisition system, the computer purchase request including at least the personalization data set.

As a computer readable medium including at least computer program code stored thereon and executable by a processor of a server computer to personalize a computer, one embodiment can, for example, include at least: computer program code for receiving a request to purchase a computer for a recipient; computer program code for determining whether the computer to be purchased is to be pre-configured for the recipient; computer program code for obtaining configuration data pertaining to the recipient; computer program code for determining pre-configuration to be provided to the computer based on the configuration data pertaining to the recipient; and computer program code for producing a pre-configured computer for the recipient based on the determined pre-configuration.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a computer purchase environment according to one embodiment of the invention.

FIG. 2 is a flow diagram of a computer purchase process according to one embodiment of the invention.

FIGS. 3A and 3B are flow diagrams of a computer purchase request process according to one embodiment of the invention.

FIG. 4 is a product personalization system according to one embodiment of the invention.

FIG. 5 is a block diagram of an exemplary computing device suitable for use with the invention.

### DETAILED DESCRIPTION OF EMBODIMENTS OF THE INVENTION

Methods, systems and apparatus for producing a pre-configured computing device are disclosed. In one embodiment, a computing device that has been purchased can be customized for a recipient prior to being delivered to the recipient. The customization can be performed based on configuration data that is associated with the recipient. The customization can, for example, vary depending on available configuration data associated with the recipient and/or user customization selections. Advantageously, the customization can personalize the computing device for the recipient such that substantially less participation (e.g., time) is required by the recipient to setup the computing device.

The computing device being customized can, for example, be a personal computer (e.g., desktop computer, portable/notebook computer or netbook computer), or a handheld electronic device (e.g., Portable Digital Assistant (PDA), multi-function mobile telephone).

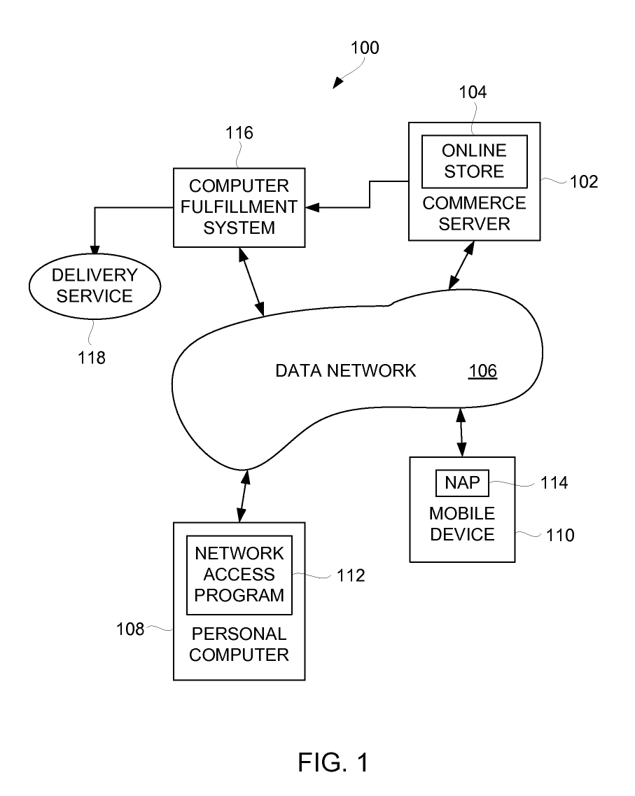

Embodiments of various aspects of the invention are discussed below with reference to FIGS. 1-5. However, those skilled in the art will readily appreciate that the detailed description given herein with respect to these figures is for explanatory purposes as the invention extends beyond these limited embodiments.

FIG. 1 is a block diagram of a computer purchase environment 100 according to one embodiment of the invention. The computer purchase environment 100 includes a commerce server 102 that hosts an online store 104. The commerce server 102 is coupled to a data network 106. Typically, the data network 106 is or provides access to a global public network, such as the World Wide Web (or Internet). Additionally, various client devices, such as a personal computer 108 or a mobile device 110, can also couple to the data network 106. In one implementation, the personal computer 108 includes a network access program (NAP) 112 that facilitates interaction between the personal computer 108 and the commerce server 102 via the data network 106. Similarly, the mobile device 110 can include a NAP 114 to facilitate interaction between the mobile device 110 and the commerce server 102 via the data network 106. In one embodiment, the NAP can pertain to a network browser program, and in another embodiment, the NAP can pertain to an application program having built-in network browser capabilities.

More particularly, the user can utilize the network access program 112 operating on the personal computer 108 to interact with the online store 104 being hosted by the commerce server 102. The network access program 112 can interact with the online store 104 using communications that can be sent and received over the data network 106. In one implementation, the user, through such interactions, can search, browse, and select a computer for purchase from the online store 104. Similarly, the user could also select a computer to be purchased using the mobile device 110.

In one embodiment, the process of purchasing a computer by way of the online store 104 can be further enhanced to provide personalization of the computer being purchased. Accordingly, in order to personalize the computer, the commerce server 102 acquires configuration data associated with the user (purchaser) for the computer being purchased. In one implementation, the configuration data associated with the user can be provided by the client device, for example, the personal computer 108, that the user is utilizing to interact with the online store 104. For example, during the purchase processing with the online store 104, the appropriate configuration data associated with the user can be transmitted by a network access program 112 (or the personal computer 108) to the commerce server 102. Alternatively, in the event that the client device being utilized interact with the online store 104 does not have the appropriate configuration data, such as for example the mobile device 110, other means of acquiring the configuration information associated with the user can be utilized.

After the commerce server 102 has processed the purchase request for a computer and received configuration data associated with the user, purchase information from the purchase request and the configuration data can be supplied to a computer fulfillment system 116. The commerce server 102 can be coupled to the computer fulfillment system 116 in a peer-to-peer manner and/or can be coupled through the data network 106. In any case, the computer fulfillment system 116 can operate to identify the computer being purchased, and then operate to personalize the identified computer for the user. More particularly, the identified computer can be personalized in accordance with the configuration data associated with the user. After the computer has been personalized, the computer can be provided to a delivery service 118 for delivery to the user. A computer can be delivered by a courier, a postal service, a mail drop, or customer pickup.

Generally speaking, although FIG. 1 illustrates the personal computer 108 and the mobile device 110, one, several or many client devices or any size can be used to access and interact with the commerce server 102 via the data network 104. Typically, the client devices are computing devices.

As noted above, the delivery service 118 can deliver the computer to a recipient. The recipient can be the user that purchased the computer or the recipient can be some other specified person. Once a recipient has received the computer that has been purchased and personalized, the computer is already configured specifically for the recipient. The user is then able to rapidly make use of the computer without having to endue various time-consuming steps to manually configuration the computer.

In one embodiment, the computer being delivered to a recipient can be secured so that unauthorized persons are not able to use the computer. In particular, the computer usage can be secured by any of a variety of ways, such as by a password or a security question. Here, the recipient would be required to authenticate themselves by providing a correct password or by answering a predetermined security question. Once the recipient is authenticated, the computer could then be used by the recipient in the normal course. Since the computer has been partially or fully personalized, the recipient need not by burdened with participating in manual configuration of the computer.

The configuration data can pertain to resources of a computing device (e.g., computer). The resources of the computing device can, for example, pertain to hardware, software, content, services, or accounts. More specifically, the configuration data can include data pertaining to one or more of: network setup, wireless network passwords, online accounts, software installed, software licenses, software preferences, software registration, locally stored status data (e.g., “cookies”), device drivers (e.g., print drivers, scanner drivers), passwords, authentication certificates, previously purchased content, licensed content, media content, media licenses, or parental controls.

Although the exact configuration data to be save and/or utilized can vary widely depending on application and implementations, some exemplary usage scenarios are described below. These exemplary usage scenarios are merely illustrative and not intended to be limiting.

First exemplary usage scenario: A user has an existing computer that is used at home on a wireless network, and has installed application programs Safari™, iTunes™ and iWork™. The Safari™ network browser has stored usage history and cookies. The iTunes application has a media library including media content that was purchased electronically, user created playlists, and various preference settings. The iWork™ word processor program has user preference settings. When the user decides to get a replacement computer, the user can visit an online store and select a new computer. The user can then purchase the new computer and have it personalized. In personalizing the new computer, the configuration data can be acquired from the existing computer. The configuration data available at the existing computer can include information on the application program Safari™ with the usage history and cookies, the application program iTunes™ with its media library, playlists and preference settings, and the application program iWork™ with its preference settings. The configuration data available at the existing computer can also include wireless network configuration information for the wireless network. Consequently, in one embodiment, the new computer can be personalized such that the application Safari™ is installed and configured to provide the usage history and cookies, the application program iTunes™ is installed and configured to provide the preference settings, with the media library and playlists also copied to the new computer, and iWork™ is installed and configured to provide the preference settings. The new computer can also be configured to support the wireless network at the home using the wireless network configuration information.

Second exemplary usage scenario: A user has installed application Safari™ having bookmarks and parental control settings. The application Safari™ also has passwords, certificates, and cookies associated therewith. When the user decides to get a replacement computer, the user can visit an online store and select a new computer. The user can then purchase the new computer and have it personalized. In personalizing the new computer, the configuration data can be acquired from the existing computer. In personalizing the new computer, the configuration data can be acquired from the existing computer. The configuration data available at the existing computer can include information on the application program Safari™ with the associated bookmarks, parental controls, passwords, certificates, and cookies. Consequently, in one embodiment, the new computer can be personalized such that the application Safari™ is installed and configured to provide the bookmarks, parental control settings, passwords, certificates, and cookies. The purchaser of the new computer can also provide a greeting, such as gift greeting, for the recipient of the new computer. The new computer can thus also be configured to include the greeting that can be presented to the recipient one or more times. The greeting is not obtained from the existing computer, but is obtained from the online store (e.g., purchaser of the new computer via the online store). Hence, not all configuration data need be obtained from the existing computer.

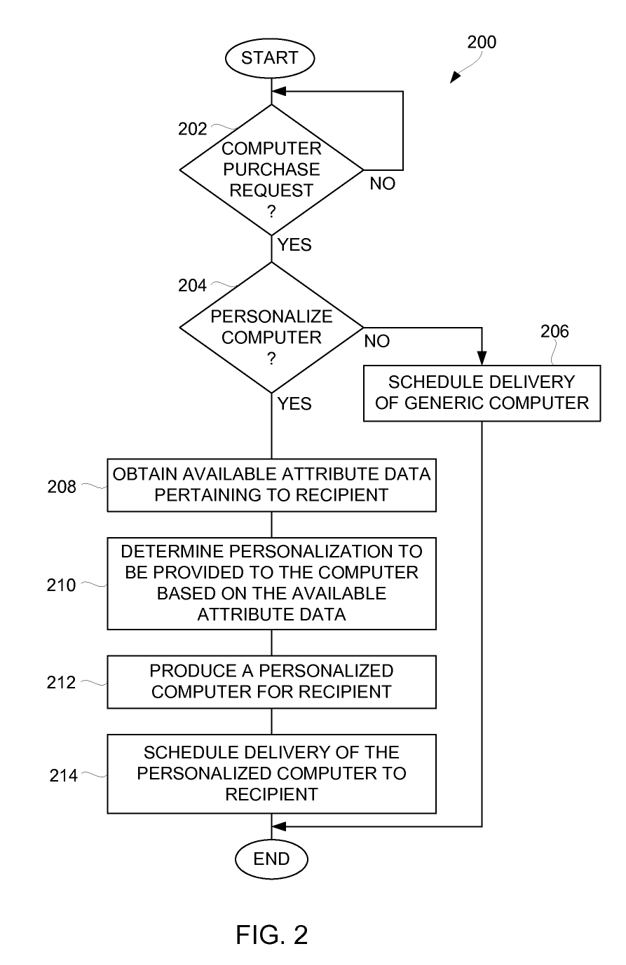

FIG. 2 is a flow diagram of a computer purchase process 200 according to one embodiment of the invention. The computer purchase process 200 can, for example, be performed by a commerce server and/or a computer fulfillment system, such as the commerce server 102 and/or the computer fulfillment system 116 illustrated in FIG. 1.

The computer purchase process 200 can begin with a decision 202 that determines whether a computer purchase request has been received. When the decision 202 determines that a computer purchase request has not been received, the computer purchase process 200 can await such a request. In other words, the computer purchase process 200 can be invoked once a computer purchase request is received.

In any case, once the decision 202 determines that a computer purchase request has been received, a decision 204 determines whether the computer being purchased is to be personalized. When the decision 204 determines that the computer being purchased is not to be personalized, delivery of a generic computer is scheduled 206. In this case, the computer being purchased is not to be personalized so the purchaser receives a generic computer (i.e., a version of the computer that is not personalized).

On the other hand, when the decision 204 determines that the computer being purchased is to be personalized, available attribute data pertaining to a recipient for the computer is obtained 208. The attribute data pertaining to the recipient can, for example, pertain to configuration information. The attribute data can be obtained from (i) a user's computer that participates in providing the computer purchase request, or (ii) a central server storing attribute data for various users/recipients. In one embodiment, the attribute data can be located using a unique identifier associated with the recipient for the computer. For example, the unique identifier can include at least one of account indicator, email address, name, and/or password.

After the available attribute data has been obtained 208, personalization to be provided to the computer can be determined 210 based on the available attribute data. Next, a personalized computer can be produced 212 for the recipient. Here, the computer being purchased is personalized in accordance with the available attribute data pertaining to the recipient. The personalization can pre-store data, install drivers, configure users, set passwords, configure accounts, configure network connections, install software, register software, and the like. After the personalized computer has been produced 212, delivery of the personalized computer to the recipient can be scheduled 214. Following the block 214, as well as following the block 206, the computer purchase process 200 can end.

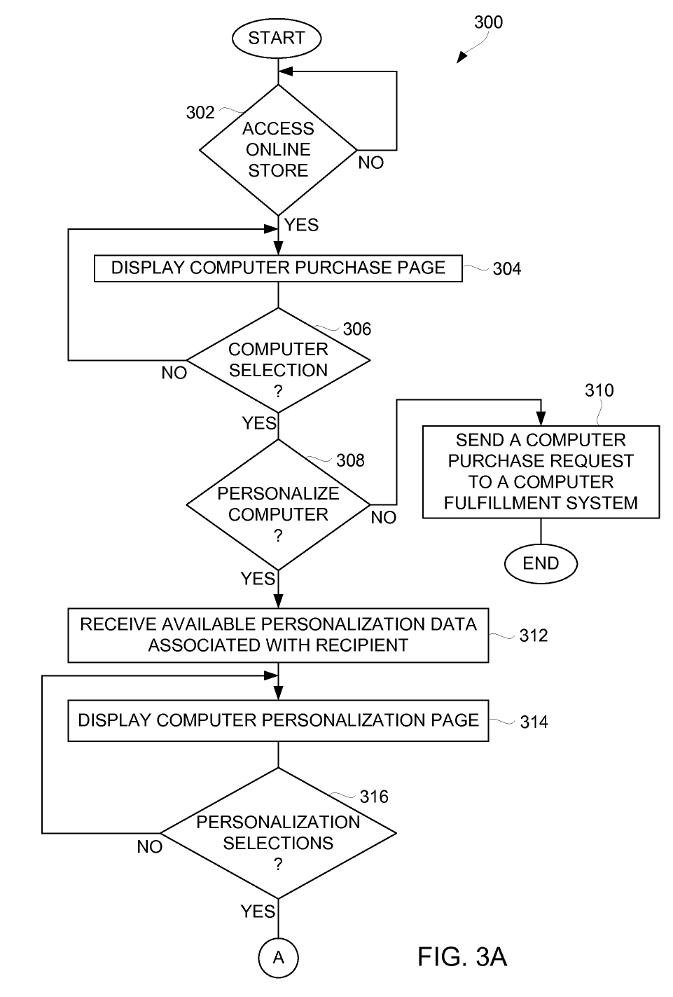

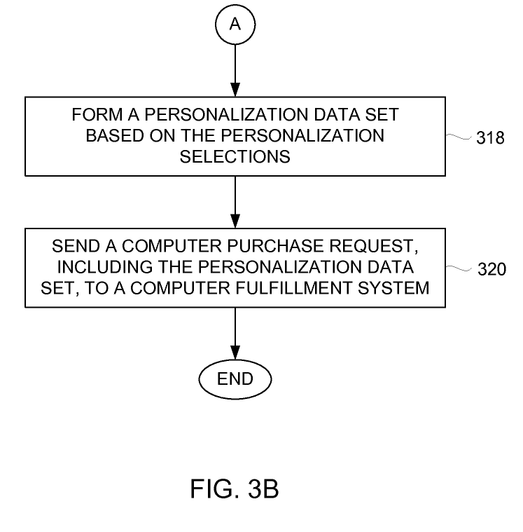

FIGS. 3A and 3B are flow diagrams of a computer purchase request process 300 according to one embodiment of the invention. The computer purchase request process 300 can be performed by a client machine, such as the personal computer 108 or the mobile device 110 illustrated in FIG. 1.

The computer purchase request process 300 can begin with a decision 302 that determines whether access to an online store is desired. When the decision 302 determines that access to an online store is not desired, the computer purchase request process 300 can await such a request. Here, the computer purchase request process 300 is effectively not invoked until access to an online store is desired.

Once the decision 302 determines that access to an online store is desired, a computer purchase page provided by the online store can be displayed 304. Here, the computer purchase page can be displayed 304 on a display screen associated with the client machine. A decision 306 can then determine whether a computer selection has been made with respect to the computer purchase page. Here, the computer selection is a selection of a computer to be purchased by a user via the online store. The computer purchase page can represent one or a series of web pages that are used to facilitate user selection of the computer to be purchased. When the decision 306 determines that a computer selection has not yet been made, the computer purchase request process 300 can return to repeat the block 304 so that the user can continue to interact with the online store so as to locate and identify a computer to be purchased.

On the other hand, when the decision 306 determines that a computer selection has been made, a decision 308 can determine whether the computer is to be personalized. When the decision 308 determines that the computer being selected is not to be personalized, a computer purchase request can be sent 310 to a computer fulfillment system. In this case, since the computer is not to be personalized, the computer purchase request simply identifies the particular type of computer being purchased. The computer fulfillment system can operate to produce and initiate delivery of the computer being purchased. Following the block 310, the computer purchase request process 300 can end.

Alternatively, when the decision 308 determines that the computer being selected is to be personalized, available personalization data associated with a recipient for the personalized computer can be received 312. In one embodiment, the personalization data can be obtained from the client machine being utilized by the user (purchaser) when purchasing the computer from the online store. In an alternative embodiment, the personalization data can be obtained from a central repository that stores data (namely, personalization data) for various users.

In any event, after the available personalization data associated with the recipient is received, a computer personalization page can be displayed 314 all on the display screen associated with the client machine. At this point, the user of the client machine can interact with the computer personalization page to make one or more personalization selections that specify the nature of personalization to be provided to the computer being purchased. For example, the computer personalization page can represent one or a series of webpages that assist the user with specifying the personalization to be provided. After the computer personalization page is displayed 314, a decision 316 can determine whether personalization selections have been made. When the decision 316 determines that the personalization selections have not yet been made, the computer purchase request process 300 can return to repeat the block 314 so that the user can make or continue to make the desired personalization selections.

Once the decision 316 determines that the personalization selections have been made, a personalization data set can be formed 318 based on the personalization selections. Next, a computer purchase request, including the personalization data set, can be sent 322 a computer fulfillment system. The personalization data set can be part of or separate from the computer purchase request. The computer fulfillment system can then process the computer purchase request to produce the personalized computer as requested by the purchaser. Following the block 320, the computer purchase request process 300 can end.

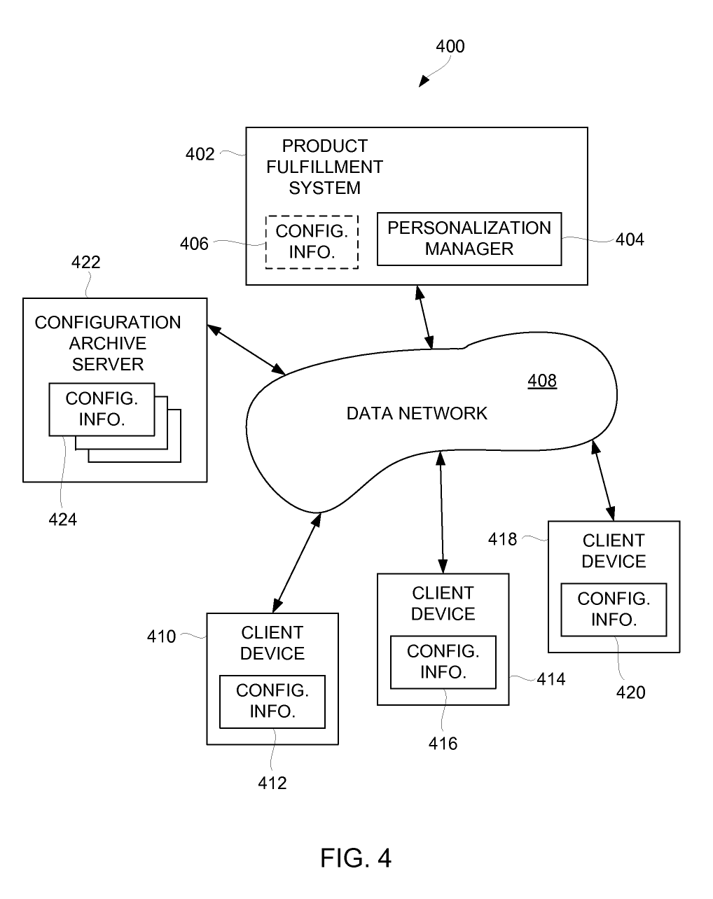

FIG. 4 is a product personalization system 400 according to one embodiment of the invention. The product personalization system 400 includes a product fulfillment system 402. The product fulfillment system 402 includes a personalization manager 404. The personalization manager 404 operates to manage the personalization of a product being produced (or provided) by the product fulfillment system 402. The personalization manager 404 can utilize configuration information 406 associated with the recipient of the product being produced. As discussed below, the configuration information 406 can be provided by a client machine that stores configuration information for a particular user or a central server that stores configuration information for a plurality of users.

The product personalization system 400 also includes a data network 408. The data network 408 can represent a wide area network, a local area network or a global network. For example, the global network can pertain to the World Wide Web (or the Internet). The product personalization system 400 also supports a plurality of client devices that are able to connect to the data network 408 in a wired or wireless manner. As shown in FIG. 4, the product personalization system 400 illustrates a client device 410 having stored configuration information 412 pertaining to its user, a client device 414 having stored configuration information 416 pertaining to its user, and a client device 418 having stored configuration information 420 pertaining to its user. The configuration information 412, 416 or 420 can be provided by the respective client device 410, 414 or 418 to the product fulfillment system 402 via the data network 408 when needed to provide product personalization by the personalization manager 404. Typically, the product fulfillment system 402 would utilize the personalization provided by the personalization manager 404 to personalize a product that has been purchased for a particular recipient. The configuration information 406 that is utilized by the personalization manager 404 to personalize the product being produced by the product fulfillment system 402 is typically associated with a recipient for a product that has been recently purchased for the recipient. The purchase can be made by the recipient or by another user for the recipient.

The product personalization system 400 can also include a configuration archive server 422. The configuration archive server 422 provides centralized data storage for configuration information 424 associated with a plurality of users. The configuration information 424 stored at the configuration archive server 422 can be periodically or on request provided to the configuration archive server 422 by a client device, such as the client device 410, 414 or 418 illustrated in FIG. 4, by way of the data network 408. Accordingly, the configuration information 406 being utilized by the personalization manager 404 can alternatively be supplied to the product fulfillment system 402 by the configuration archive server 422. For example, when a user purchases a computer from an online store from a client device (e.g., computer) that does not maintain configuration information for the user, then it may be possible to retrieve the configuration information from the configuration archive server 422. As another example, when a user purchases a computer from an online store for another recipient, then it may be possible to retrieve the configuration information for the recipient from the configuration archive server 422.

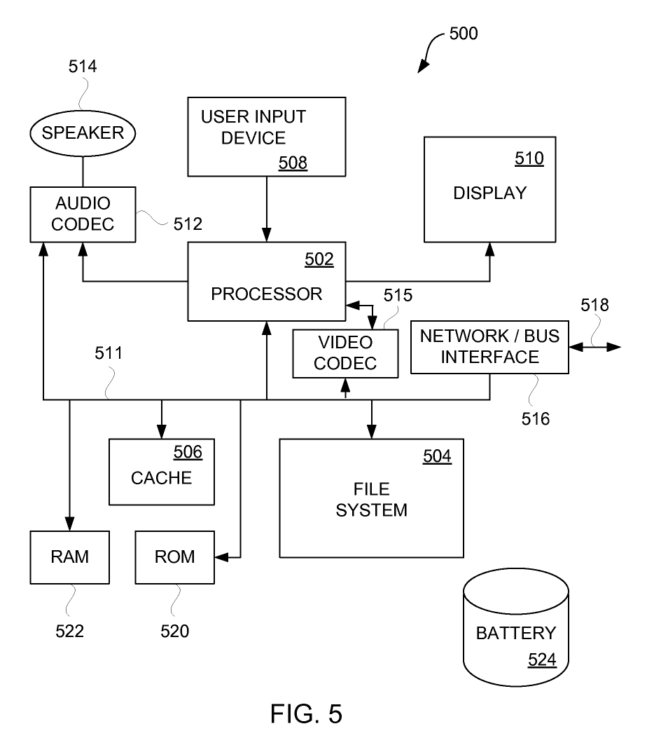

FIG. 5 is a block diagram of an exemplary computing device 500 suitable for use with the invention. The computing device 500 illustrates circuitry of a representative portable computing device.

The computing device 500 includes a processor 502 that pertains to a microprocessor or controller for controlling the overall operation of the computing device 500. The computing device 500 stores data pertaining to electronic files in a file system 504 and a cache 506. The file system 504 is, typically, semiconductor memory (e.g., Flash memory) and/or one or more storage disks. The file system 504 typically provides high capacity storage capability for the computing device 500. However, since the access time to the file system 504 can be relatively slow, the computing device 500 can also include the cache 506. The cache 506 is, for example, Random-Access Memory (RAM) provided by semiconductor memory. The relative access time to the cache 506 is typically shorter than for the file system 504. However, the cache 506 does not have the large storage capacity of the file system 504. Further, the file system 504, when active, consumes more power than does the cache 506. The power consumption is often a concern when the computing device 500 is a portable computing device that is powered by a battery 524. The computing device 500 also includes a Read-Only Memory (ROM) 520 and a RAM 522. The ROM 520 can store programs, utilities or processes to be executed in a non-volatile manner. The RAM 522 provides volatile data storage, such as for the cache 506.

The computing device 500 also includes a user input device 508 that allows a user of the computing device 500 to interact with the computing device 500. For example, the user input device 508 can take a variety of forms, such as a button, keypad, dial, touch-sensitive surface, etc. Still further, the computing device 500 includes a display 510 (screen display) that can be controlled by the processor 502 to display information to the user. A data bus 511 can facilitate data transfer between at least the file system 504, the cache 506, the processor 502, an audio coder/decoder (CODEC) 512 and/or a video CODEC 515.

In one embodiment, the computing device 500 serves to store a plurality of media items (e.g., songs, videos, podcasts, etc.) in the file system 504. When a user desires to have the computing device play a particular media item, a list of available media items is displayed on the display 510. Then, using the user input device 508, a user can select one of the available media items. The processor 502, upon receiving a selection of a particular media item, supplies the media data to one or more appropriate output devices. If the particular media item is encrypted, the particular media item is first decrypted as noted above, which could involve one or more layers of encryption. As an example, for audio output, the processor 502 can supply the media data (e.g., audio file) for the particular media item to the audio CODEC 512. The audio CODEC 512 can then produce analog output signals for a speaker 514. The speaker 514 can be a speaker internal to the computing device 500 or external to the computing device 500. For example, headphones or earphones that connect to the computing device 500 would be considered an external speaker. As another example, for video output, the processor 502 can supply the media data (e.g., video file) for the particular media item to the video CODEC 515. The video CODEC 515 can then produce output signals for the display 510 and/or the speaker 514.

The computing device 500 also includes a network/bus interface 516 that couples to a data link 518. The data link 518 allows the computing device 500 to couple to another device (e.g., another computing device, server computer, a host computer, or an accessory device). The data link 518 can be provided over a wired connection or a wireless connection. In the case of a wireless connection, the network/bus interface 516 can include a wireless transceiver. The data link 518 can, in some cases, also provide power to the computing device 500 (e.g., to charge the battery 524).

A portable electronic device illustrated in FIG. 5 may, but need not, be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels. Even smaller, and thus more portable devices, are wearable electronic devices.

In general, electronic files included within the aggregated data storage provided across computing devices associated with a user can pertain any of a variety of different type of data. For example, one or more of the electronic files might pertain to word processing documents, spreadsheets, databases, contacts, media content (audio, video, image), etc.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for producing a personalized computer, said method comprising:
receiving a request to purchase a computer, the request including a unique identifier associated with a purchaser;
retrieving, from an on-line repository, configuration data associated with the purchaser using at least the unique identifier;
personalizing the computer being purchased based at least in part on the retrieved configuration data; and
thereafter delivering the personalized computer to the purchaser.

2. A method as recited in claim 1, wherein the computer is personalized during manufacturing or assembling of the computer.

3. A method as recited in claim 1, wherein the computer is a personal computer.

4. A method as recited in claim 1, wherein the configuration data includes data pertaining to one or more of network configuration, account configuration, desktop configuration, language configuration, software configuration, and geographic configuration.

5. A method as recited in claim 1, wherein the unique identifier is an account indicator.

6. A method as recited in claim 1, wherein said personalizing configures the computer being purchased specifically for the purchaser.

7. A computer fulfillment system, comprising:
a request interface configured to receive a computer purchase request specifying a computer being purchased, the computer purchase request also including or referencing configuration information to be utilized in configuring the computer being purchased;
a memory configured to store the configuration information to be utilized in configuring the computer being purchased;
a personalization manager operatively connected to the request interface, the personalization manager being operable to pre-configure the computer being purchased based at least in part on the configuration information stored in the memory; and
a delivery interface thereafter configured to initiate delivery of the pre-configured computer to a recipient.

8. A computer fulfillment system as recited in claim 7, wherein the configuration information to be used by the personalization manager is specifically associated with the recipient.

9. A computer fulfillment system as recited in claim 7, wherein the configuration information includes data pertains to a plurality of network configuration, account configuration, desktop configuration, language configuration, software configuration, and geographic configuration.

10. A method of producing a personalized computer, said method comprising:
receiving a request to purchase a computer for a recipient;
determining whether the computer to be purchased is to be personalized;
obtaining available attribute data pertaining to the recipient;
determining personalization to be provided to the computer based on the available attribute data pertaining to the recipient; and
producing a personalized computer for the recipient based on the determined personalization.

11. A method as recited in claim 10, wherein said method comprises:
scheduling delivery of the personalized computer that has been produced specifically for the recipient.

12. A method as recited in claim 10, wherein the request to purchase the computer is an online request.

13. A method as recited in claim 12, wherein the online request to purchase the computer is initiated from a current computer.

14. A method as recited in claim 13, wherein the available attribute data is obtained from the current computer and provided with the request.

15. A method as recited in claim 14, wherein the at least a portion of the available attribute data includes at least local network configuration data.

16. A method as recited in claim 14, wherein the at least a portion of the available attribute data includes at least local account configuration data.

17. A method as recited in claim 14, wherein the at least a portion of the available attribute data includes at least local software configuration data.

18. A method as recited in claim 12, wherein said obtaining of the available attribute data comprises:
accessing a remote server over a network to retrieve at least a portion of the available attribute data pertaining to the recipient.

19. A method as recited in claim 18, wherein the recipient is the person initiating the request to purchase the computer.

20. A method as recited in claim 18, wherein the recipient is a person other than the person initiating the request to purchase the computer.

21. A method of producing a personalized computer, said method operating on a client device, said method comprising:
interacting with a remote online commerce server to purchase a computer;
querying a user of the client device whether the computer being purchased is to be personalized for a recipient;
retrieving available personalization data associated with the recipient;
displaying personalization options for the computer being purchased based on the available personalization data;
receiving a selection of one or more of the personalization options from the user;
forming a personalization data set based on the one or more of the personalization options selected and based on the available personalization data; and
sending a computer purchase request to a computer acquisition system, the computer purchase request including at least the personalization data set.

22. A method as recited in claim 21, wherein said obtaining of the available attribute data comprises:
accessing a client computer from which the online request to purchase the computer is being made; and
retrieving at least a portion of the available attribute data from the client computer.

23. A method as recited in claim 22, wherein the at least a portion of the available attribute data includes at least local network configuration data.

24. A method as recited in claim 22, wherein the at least a portion of the available attribute data includes at least local account configuration data.

25. A method as recited in claim 22, wherein the at least a portion of the available attribute data includes at least local software configuration data.

26. A method as recited in claim 22, wherein said obtaining of the available attribute data comprises:
accessing a remote server over a network to retrieve at least a portion of the available attribute data pertaining to the recipient.

27. A method as recited in claim 21, wherein the recipient is the person initiating the request to purchase the computer.

28. A method as recited in claim 21, wherein the recipient is a person other than the person initiating the request to purchase the computer.

29. A method as recited in claim 21, wherein the computer acquisition system is provided by a computer manufacturer.

30. A computer readable medium including at least computer program code stored thereon and executable by a processor of a server computer to personalize a computer, said computer readable medium comprising:
computer program code for receiving a request to purchase a computer for a recipient;
computer program code for determining whether the computer to be purchased is to be pre-configured for the recipient;
computer program code for obtaining configuration data pertaining to the recipient;
computer program code for determining pre-configuration to be provided to the computer based on the configuration data pertaining to the recipient; and
computer program code for producing a pre-configured computer for the recipient based on the determined pre-configuration.
